(19) United States
(12) Patent Application Publication
(10) Pub. No.: US 2021/0097497 A1
(43) Pub. Date: Apr. 1, 2021

(54) Systems and Methods for Compliance with and Monitoring of Incentive Programs

(71) Applicant: Jane Vancil, Lake Saint Louis, MO (US)

(72) Inventor: Jane Vancil, Lake Saint Louis, MO (US)

(21) Appl. No.: 17/081,563

(22) Filed: Oct. 27, 2020

Related U.S. Application Data
(63) Continuation of application No. 15/951,851, filed on Apr. 12, 2018.
(60) Provisional application No. 62/484,881, filed on Apr. 12, 2017.

(51) Int. Cl. G06Q 10/10

(52) U.S. Cl. CPC G06Q 10/1057; G06Q 10/1053

(57) ABSTRACT

Systems and methods that enable an employer to better monitor the actual “jobs” they have open or created in any particular location, to determine if they are complying with incentive programs they have obtained. The system also allows for a governmental or other entity to monitor compliance with such requirements by reviewing the same data. One of the primary outputs of the system and method are generally verified reports that show compliance because they are focused on the creation and loss of “jobs” as opposed to employees. The: systems and methods allow for entities on both sides of the equation to be comfortable that reports are accurate, and to monitor compliance with the programs.

### CROSS REFERENCE TO RELATED APPLICATION(S)

This Application is a Continuation of U.S. patent application Ser. No. 15/951,851 filed Apr. 12, 2018. Priority benefit is claimed to application Ser. No. 15/951,851 and to U.S. Provisional Patent Application 62/484,881, filed Apr. 12, 2017. The disclosures of these applications are incorporated herein by reference, each in its entirety.

### BACKGROUND

### 1. Field of the Invention

This disclosure relates to the field of systems and methods for monitoring and. reporting compliance with tax incentives or other employment based requirements imposed by governmental or similar entities. Specifically, it provides for a system and method that allow for a user to correctly report compliance for complicated human resources arrangements which require an understanding of specific numbers of jobs.

### 2. Description of the Related Art

Incentives, and particularly tax incentives, are a common vehicle by which governments attempt to attract businesses to their region. While there are huge numbers of different types and methods of providing incentives, they all generally boil down to a few key elements. Specifically, a tax incentive generally involves a government voluntarily giving up a certain amount of collectable income for a period of time (in the form of taxes it is entitled to collect) to reduce the cost born by a business or other entity which wishes to expand, relocate, or startup in a region to which that government has some attachment. This is done in order to encourage the business to carry out such expansion or relocation and, therefore, increase the number of jobs available to people in the region.

Reasons for doing this can be diverse, but they generally relate to government recognition. that the government cannot always fully provide for every need of their citizenry, and that the government and citizens can often gain increased benefits by allowing a private sector actor to fill a need for them. The primary need that the government cannot directly provide is employment of the jurisdiction's citizens and employment is crucial both for the standard of living of the people governed and to cover the expenses of the government itself. While a large number of individuals are employed by governments, governments cannot increase local employment by themselves. Government wages require the collection of taxes, and the taxes generally have to be collected from someone employed by an entity other than the government to prevent a zero sum arrangement.

In effect, increased employment (recognizing that this term refers to work outside the realm of an activity such as subsistence farming) of people within a region creates more resources for the region. A key element of employment, however, is that the system only works if the employed provide more resources for the region than they consume. Thus, having residents who are not employed or underemployed can create situations where they consume more resources than they can provide and these provide a negative to the government entity. Thus, the equation of successful employment for a region requires interplay of three major variables. The first of these is the total population, the second of these is the percentage of those that are employed, and the third is the wages (usually provided as some form of average) of those that are employed. Generally, an increase in any variable (with the remaining staying constant) will improve the resources available to the region.

Thus, governments will often use tax incentives to encourage the employment of local individuals by third party businesses. Specifically, they are generally used to get the business, in whatever fashion, to expand the number of jobs it has available that employ those in the government's covered region. The availability of jobs is, therefore, thought to increase at least one of the variables. Hither population comes from outside to fill the jobs, locals who are currently not employed fill the jobs, or the lack of available labor increases the average wage the labor can demand and is paid (which effectively is a flow of capital into the region).

Tax incentives are designed to allow the third party business to obtain labor at an initially cheaper rate (since the government is not reducing the wage of the employee by a tax rate either directly or indirectly depending on the system) which can offset costs associated with creating those jobs. The benefit to the government is that the government forgoes initial income from the business with regards to the employees filling those jobs to get employment up, and gain the benefits associated with that To put this another way, the government forgoes a stream of income in exchange for the investment of capital by a private actor or from the other side, the private actor obtains a release from a stream of expenses in exchange for an agreement to provide upfront capital expense.

The tradeoff of a stream of income for a current value is a well-understood relationship commonly referred to as Net Present Value (NPV) analysis in economics. NPV simply is an indication of how much value money obtained at a later date has today. In its simplest form if one had $100 today, it could be invested at 5% per year interest and the person would have $105 a year from now. Thus, the person would obtain the same NPV from having $105 in a year, or $100 today.

Tax incentives are believed to work because they are supposed to result in accelerated growth (investment) by getting growth now through application of the incentive, instead of over time in a more organic fashion. While the concept and actual monetary benefit of economic “growth” is a bit ambiguous, it essentially boils down to the government gambling that increased employment now will provide a greater NPV (in a variety of areas) later than it cost.

Tax incentives, however, are often disfavored because the economics and math are very complicated. In the first instance, generally the creation of any new job actually acts on multiple of the factors, As a simple example, creation of a low wage job may decrease unemployment, but the employed person may consume more resources than they did when they were unemployed now resulting in a net negative to the local economy. Further, the creation of any new job or expansion of any business may serve to both provide additional economic benefit to one actor, and to cannibalize economic benefit to another. For example, increasing the wages of one worker may result in lower the wages of another. Thus, it can be unclear if tax incentives actually work as it often matters how the benefits and costs fall in each particular region versus other regions. For example, building a particular store may result in increased employment at. that store, but may result in a prior existing store in a competing retail space to close (resulting in increased. unemployment) as the latter looses sales to the former.

Far these kind of reasons, politicians and their constituents often assert tax incentives are harming the economy because the forgoing of income that the government can spend elsewhere is simply going to select winners and losers within the region, as opposed to actually helping the region as a whole. The problem is that in any geographic region which has competing geographic areas offering tax incentives create a prisoner's dilemma where not offering the incentive may lead to a loss, even if there is relatively little benefit from offering it.

While, as discussed above, is that it is often very difficult to determine if the government entity, or the governed region, actually makes or loses money in the incentive process, if one takes the position that tax incentives need to be offered to compete with other regions, the second problem becomes clear. How to insure compliance and see if any improvement in the long term is actually realized, This problem exists because the tax incentive generally uses two disconnected calculations. The government spends money (which could be used to acquire other things such as road repair which could effect money they get from elsewhere) while the government gets “jobs” which is essentially a non-existent thing, but it recognizably tied to employment. While it is clear that increased employment will result in increased tax collection (more jobs means more money for the government), it is often not clear what the actual mathematical relationship is and it is complicated by the fact that job creation both spurs additional job creation, and cannibalizes from other jobs. In the same way it is impossible to have 0% unemployment (even with vastly more employers looking to hire than ate able to), it is very hard to clearly show when a “job” is actually exulted. This problem is not one that has been proven to be readily solvable as the interrelationships related to a new lob” are simply too complicated in any large scale evaluation.

The need to be able to count “jobs” provided by any employer is valuable because it has been generally recognized that to the extent that a certain geographic region can spur job creation (growth), at the expense of other regions, this should create localized improvements. Basically, while the tax incentive may be a zero sum game at a macro level, at a more micro level. different regions can benefit at others expense. Thus, to the extent that a government can de-fine itself against another region, tax incentives can work if they spur growth compared to regions that are sufficiently disconnected from the region of interest. Further, increasing local employment and local growth usually correlate with each other. Thus, so long as the new “jobs” which are being created which are actually connected to the region looking for growth, there should be a positive effect as cannibalization from other local business may not be as large as the growth. To put it simply, if one business clearly added 100 jobs, it may likely be the case that this creates somewhere between 1 and 100 new jobs in the region, even taking into account cannibalization of other local positions. That is, it is unlikely that an employer can fill all their positions from already employed local employees, without the employers those employees left having to refill at least some of their positions. Thus, the creation of 100 jobs clearly should increase regional employment.

However, the rub for governments on this is making sure that they actually get what they pay for and this, ultimately, comes down to whether or not a local job has been created by the employer who said they were going to. Governments have struggled, as some recent data has shown, to even figure out if the “jobs” they paid for were actually created or not. Outside of the problem of labor cannibalization between businesses exacerbating the problem of determining how many net jobs are created, simply determining if the incentivized business actually has created a target number of “jobs,” (as opposed to more or fewer employees) is difficult. This means that the primary problem for a government is making sure that the employer receiving the incentive is compliant with the requirement they agreed to and actually provides and maintains the jobs, within the government entity's jurisdiction.

Incentive structures of government, and particularly tax incentives, generally aim to increase jobs within a defined geographic region as the requirement for getting the incentive. The key elements of the jobs requirements are that the jobs need to be in the same governmental jurisdiction (although they may be at different facilities) and that the employer needs a net increase in the number of additional jobs within a certain time period. To put this simply, the total number of people who can be employed within the governmental jurisdiction needs to go up, not the number of people actually employed within the jurisdiction. To simplify, the employer has to have a specific number more “jobs” available at the end of the window than at the start regardless of how many people arc actually currently employed by that employer.

While one would consider that this should be an easy calculation, it is anything but. Simply looking if the number of people employed in a location at the end of this time period is larger than the prior time period is inaccurate. A number of employees does not actually directly show the number of jobs. For example, a company with 10 employees and 10 vacant positions that is actively recruiting is actually providing “jobs” for more people than a company with 15 current employees and a hiring freeze. The number of employees does not equal number of jobs available except in ‘United circumstances. There is always some turnover in employees and jobs may be filled or vacant at any instant. This is the same reason why 0% unemployment is effectively impossible. With a big enough number of potential employees, there will always be someone transitioning from or two a position. Thus, one cannot count jobs available by current employees because the necessity of turnover throws the numbers. The disconnect between number of employees and lobs” gets bigger the more employees (and jobs) that a business has in the area.

As job turnover rates change within different jobs and over time, trying to track ‘jobs” in a region has previously become enormously difficult. Thus, governments have often defaulted to two “indicators” of the number of jobs. Specifically, this is both macro and micro number of employees. At the macro level, the availability of jobs is often proxied by evaluating the local unemployment rate over time using a fixed target, which is commonly about 3%, as indicating “full” employment. As a region gets closer to “full” employment, it becomes clear that increased employees (and not necessarily “jobs”) are necessary. Similarly, when unemployment increases, more jobs are necessary. The same type of calculation is often used for micro calculations of determining if a business is in compliance with an incentive. If they have more employees, they have increased the number of jobs. The problem with both these calculations, however, is that they show delayed trends. Since government actions and reporting ideally need to be proscriptive instead of reactive, this is highly problematic.

At the micro level, for a business to report compliance traditionally, a human resources (HR) department, and HR software, keeps track of employees. HR software will generally assign each employee a number and it will monitor that employee by the number to determine if the employee is employed or not. The number of employees at the end of the reporting period would then be shown to show compliance with the incentive. However, that number does not always take into account what the employee is doing, what position they filled when they were hired, and where they are employed. As governments will often put specific requirements on incentives (specifically increasing “local jobs”), tracking individual employees does not work, instead it is necessary to truly track the abstract of “jobs” which most HR departments are not equipped to do.

In the easy example, a first employee quits and his replacement is hired. For purposes of the tax incentive, there is no gain or loss on “employee” count but there is a gained and a lost job. This is often referred to as “backfilling” as the employer generally must maintain the jobs that they originally had before they can get credit tier adding new ones. However, the calculation can get vastly more complicated as the motion of employees and the needs of the employer change. It is particularly true because the “first in” hire may not actually replace the “last out” departure due to the time it takes to fill a position. The above implicitly assumes that the next hire filed the specific vacancy of the last departure, but that will often not be the ease for a large organization and there may still be a vacancy indicating that a job was created, but not yet tilled in the above scenario or that a second employee actually left previously.

A second problem in using employees as a stand-in for jobs is that an employee may not leave the company, but may leave the jurisdiction if the employer has multiple facilities. For HR software, this is a case where it may not be clear that backfilling a job is necessary because the employee still exists, so there is no clear vacancy to be filed, even though a job has been lost based on the requirements of the incentive program. The system can be further complicated if the company had previously grown, but is now contracting and is simultaneously moving operations around. For example, if they are moving some employees from the jurisdiction, while others are moving to the jurisdiction, it may not be clear how many of the no longer present employees are at each location after the shuffling is complete.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art described herein are systems and methods that enable an employer to better monitor the actual “jobs” they have in any particular location, to determine if they are complying with incentive programs they have obtained. The system also allows for a governmental or other entity to monitor compliance with such requirements by reviewing the same data. One of the primary outputs of the system and method are generally verified reports that show compliance-because they are focused on the creation and loss of “jobs” as opposed to employees. The systems and methods allow for entities on both sides of the equation to be comfortable that reports are accurate, and to monitor compliance with the programs.

There is described herein, among other things, a method for ensuring compliance with a job creation based incentive, the method comprising: creating an incentive for an employer, said incentive requiring creation of a fixed number of additional jobs within a certain time period; at the start of the time period: creating a list of employees of the employer, each employee in the list being classified as a base job; during the time period: when an employee classified as a base job leaves the employer, replacing that employee in the list with a base job vacancy; when a new employee is hired by the employer, determining if there is currently a base job vacancy in the list: if there is a base job vacancy in the list, classifying the new employee as a base job and replacing the base job vacancy in the list with the new employee; if there is not a base job vacancy in the list, classifying the new employee as a new job and adding the new employee to the list; when an employee classified as a new job leaves, eliminating the employee classified as a new job from the list; at the end of the time period: calculating a total number of added jobs, where the total number of added, jobs equals the sum of: the number of base job vacancies in the list and the number of employees classified as new jobs in the list; comparing the total number of added jobs to the fixed number of additional jobs: if the total number of added jobs is equal to or greater than the fixed number of additional jobs, awarding the incentive to the employer; and if the total number of added jobs is less than the fixed number of additional jobs, denying the incentive to the employer.

There is also described herein a method for ensuring compliance with a job creation based incentive, the method comprising: creating an incentive for an employer, said incentive requiring creation of a fixed number of additional jobs within a certain time period, said jobs having a fixed criteria; at the start of the time period: creating a list of employees of the employer, each employee in the list being classified as a base job; during the time period; when an employee classified as a base job leaves the employer, replacing that employee in the list with a base job vacancy; when there is a base jab vacancy, determining if there is an employee classified as surplus: if there is an employee classified as surplus on the list, reclassify the employee classified as surplus as base arid delete the base job vacancy; if there is not an employee classified as surplus, do nothing; when a new employee is hired by the employer, determining if there is currently a base job vacancy in the list: if there is a base job vacancy in the list, classifying the new employee as a base job and replacing the base job vacancy in the list with the new employee; if them is not a base job vacancy in the list, determining if the new employee has a job meeting the fixed criteria: if the new employee has a job meeting the fixed criteria, classifying the new employee as a new job and adding the new employee to the list; if the new employee does not have a job meeting the fixed criteria, classifying the new employee as a surplus job and adding the new employee to the list; when an employee classified as a new job leaves, eliminating the employee classified as a new job from the list; when an employee classified as a surplus job leaves, eliminating the employee classified as a surplus job from the list; at the end of the time period: calculating a total number of added jobs, where the total number of added jobs equals the sum of; the number of base job vacancies in the list and the number of employees classified as new jobs in the list; comparing the total number of added jobs to the fixed number of additional jobs: if the total number of added jobs is equal to or greater than the fixed number of additional jobs, awarding the incentive to the employer; and if the total number of added jobs is less than the fixed number of additional jobs, denying the incentive to the employer.

The above methods may, in an embodiment, be implemented by instructions (software) stored on a computer readable media (memory), by a hardware device or system built to perform the methods either as part of the hardware therein or as software running thereon, or in any other fashion.

### BRIEF DESCRIPTION OF THE DRAWINGS

FIG. 1 is an example of government program parameters available for selection in the calculation process. All calculations in the cloud computing environment are dependent up a specific program and a specific contract

FIGS. 2A and 2B are an example of display screens of a user interface for showing legal entity fields often mandatory for incentive project management and incentive benefit calculation under government incentive programs of the type discussed with reference to FIG. 1

FIG. 3 is an example of a display screen of a user interface for showing work location fields mandatory for incentive project management and incentive benefit calculation under government incentive programs.

FIGS. 4, 5, and 6 are examples of display screens of a user interface for showing incentive project fields mandatory for incentive project management and incentive benefit calculation under government incentive programs.

FIGS. 7A and 7B are examples of display screens of a user interface for showing work location reporting for legal entities and locations are party to incentive contracts and are non-panics to incentive contracts.

FIG. 8A, FIG. 8B and FIG. 8C comprise an example of upload (import) data into the cloud computing environment. A template is available within the system which may be modified by the user. Or, user may upload from a .csv, or Excel file.

FIGS. 9A and 9B are a flow diagram of the method of providing sequence data to the cloud computing environment of the type discussed with reference to FIG. 1.

FIGS. 10A and 10B are an example of a report generated by the cloud computing environment that supports incentive benefit calculations to be submitted as compliance with specific incentive contracts or programs.

FIG. 11 shows a display illustrating specific employee backfilling in a system which utilizes backfilling at the end of the month or reporting period.

FIG. 12 shows a display illustrating specific employee backfilling in a system which utilizes backfilling in an immediate first out first in arrangement.

FIGS. 13A, 13B, 13C, and 13D illustrate various database entries showing backfill of employees.

### DESCRIPTION OF THE PREFERRED EMBODIMENT(S)

Throughout this disclosure, the term “computer” describes hardware which generally implements functionality provided by digital computing technology, particularly computing functionality associated with microprocessors, The term ‘computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not ‘limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID driven and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation a network server farm, “cloud” computing system, software-as-a-service, or other distributed or collaborative computer network

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

For purposes of this disclosure, there will also be significant discussion of a special type of computer referred to as a “mobile communication device” or simply “mobile device”. A mobile device may be, but is not limited to, a smart phone, tablet PC, e-reader, satellite navigation system (“SatNav”), fitness device (e.g. a Fitbit™ or Jawbone™) or any other type of mobile computer whether of general or specific purpose functionality. Generally speaking, a mobile device is network-enabled and communicating with a server system providing services over a telecommunication or other infrastructure network. A mobile device is essentially a mobile computer, but one which is commonly not associated with any particular location, is also commonly carried on a user's person, and usually is in near-constant real-time communication with a network allowing access to the Internet.

As will be appreciated by one skilled in the art, some aspects of the present disclosure may be embodied as a system, method or process, or computer program product. Accordingly, these aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a bard disk, a random access memory (RAM), a read-only memory (ROM), aft erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may he any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination ‘thereof. A computer readable signal medium may be any computer readable medium that is not a computer readable storage medium and that can communicate, propagate, or transport a program for use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run=time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here arc contemplated to use computers and computer software typically stored in a computer- or machine-readable storage medium or memory. The term “app” may be used to generally refer to a particular software element, of any kind, which is designed specifically to run on a mobile communication device.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the terms “web,” “web site,” “web server,” “web client,” and “web browser” refer generally to computers programmed to communicate over a network using the Hypertext Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

Throughout this disclosure, the term “real-time” refers to software operating within operational deadlines for a given event to commence or complete, or for a given module, software, or system to respond, and generally invokes that the response or performance time is, in ordinary user perception and considered the technological context, effectively generally cotemporaneous with a reference event. Those of ordinary skill in the art understand that “real-time” does not literally mean the system processes input and/or responds instantaneously, but rather that the system processes and/or responds rapidly enough that the processing or response time is -within the general human perception of the passage of time in the operational context of the program. Those of ordinary skill in the art understand that, where the operational context is a graphical user interface, “real-time” normally implies a response time of no more than one second of actual time, with milliseconds or microseconds being preferable, However, those of ordinary skill in the art also understand that, under other operational contexts, a system operating in “real-time” may exhibit delays longer than one second, particularly where network operations are involved.

The system contemplated herein generally comprises a computer system, method, software, and program which operates over the web, or another large network, in what is commonly referred to as a cloud computing environment. As used herein, the term “cloud” or “cloud computing environment” may refer to various evolving arrangements, infrastructure, networks, and the like that will typically be based upon the Internet. The term may refer to any type of cloud, including client clouds, application clouds, platform clouds, infrastructure clouds, server clouds, and so forth. As will be appreciated by those skilled in the art, such arrangements will generally allow for use by owners or users of sequencing devices, provide software as a service (SaaS), provide various aspects of computing platforms as a service (PaaS), provide various network infrastructures as a service (IaaS) and so forth. Moreover, included in this term should be various types and business arrangements for these products and services, including public clouds, community clouds, hybrid clouds, and private clouds. Any or all of these may be serviced by third party entities. However, in certain embodiments, private clouds or hybrid clouds may allow for sharing of sequence data and services among authorized users.

The system will typically include a plurality of distributed nodes where the computing resources of the nodes are pooled to serve multiple consumers, with different physical and virtual resources dynamically assigned and reassigned according to consumer demand. Examples of resources include storage, processing, memory, network bandwidth, and virtual machines. The nodes may include servers associated with one or more providers. For example, certain programs or software platforms may be accessed via a set of nodes provided by the owner of the programs while other nodes are provided by data storage companies, Certain nodes may also be overflow nodes that are used during higher load times.

A cloud management module may be responsible for load management and cloud resources. The load management may be implemented through consideration of a variety of factors, including user access level and/or total load in the cloud computing environment (peak times versus average load times). The project type may also he considered. In one embodiment, compliance filing deadlines may cause prioritization over other types of projects.

The nodes are generally configured to act as servers and communicate with various client computers. The communication with the cloud computing environment may include communication via a local area network (LAN), a general wide area network (WAN), and/or any public network (e.g., the Internet).

The nodes may also be accessed by other types of clients, such as secondary users or third party software holders. Accordingly, the system may provide different types of services depending on the access level of the particular client. A client may have access to storage and data analysis services, while a secondary user may have access only to shared or public services. Third party software holders may negotiate with clients to determine appropriate access privileges. For example, open source software may he offered for free or on a limited license basis, while other types of software may be offered according to various fee or subscription bases.

A user may interact with the system through any client including a computer or mobile device. In certain embodiments, the upload data may be accessed through security parameters such as a password-protected account. The sequence data may be accessed by downloading one or more files or by logging into a web-based interface or software program that provides a graphical user display in which the upload data is depicted as text, images, and/or hyperlinks. In such an embodiment, the data may be provided to the primary or secondary user in the form of data packets transmitted via a communications link or network. The system will typically provide user interaction software (e.g., via a web-based interface or application platform) that provides a graphical user interface (GUI) for users.

The memory architecture may include at least one program product having a set (e.g., at least one) of program modules implemented as executable instructions that are configured to carry out the functions of the present techniques. For example, executable instructions may include an operating system, one or more application programs, other program modules, and program data. Generally, program modules may include routines, programs, objects, components, logic, data structures, and so on, that perform particular tasks or implement particular abstract data types, Program modules may carry out the functions and/or methodologies of the techniques as described herein including, but not limited to, primary sequence data analysis and secondary sequence analysis

In operation the system will act to store, analyze, manage, and track generally non-personally identifiable employee data to insure that jobs are correctly reported in conjunction with a particular government incentive program. Specific sequence data generated by human resource, payroll, CRM, ERP and any other similar computer database system that holds employee records and payroll data may be uploaded to the system sequentially. Analysis of the uploaded may be performed in the system and analysis parameters are set within the system. Specific portions of the uploaded sequence data may be used to track, manage and calculate government hiring and retention incentive benefits on 1) base jobs (also referred to as “retained jobs”) at a) a specific physical location in a US State or US territory and b) all physical locations within the boundaries of any US State or territory and c) all physical locations within the US and its territories in aggregate; and 2) net new jobs at a) a specific location in a US State or US territory and b) all physical locations within the boundaries of any US State or territory and c) all physical locations within the US and its territories in aggregate; and 3) surplus jobs at a) a specific physical location in a US State or US territory and h) all physical locations within the boundaries of any US State or territory and c) all physical locations within the US and its territories in aggregate. The sequence data may be shared by a user of the system with other users such as to provide a formal report to a governmental entity during the reporting period for the incentive.

It is important to recognize that ‘jobs” (or more accurately “project jobs”), as discussed herein are jobs associated with a particular incentive program and do not necessarily equal specific employment positions or employees. “Jobs” as used herein, effectively refers to an abstract position (or “opening”) which may be filled or vacant at any instant and is examined at a macro level of the business. However, the key is that a vacant job is only vacant because the employee to fill it has not yet been located and that generally the only reason they have not is that there has not been enough time passed since it became vacant. To put this another way, jobs are generally created in a time window if the net of all employee turnover is positive at the end of the window (more people added than lost). However, the specific number of jobs created in the window cannot be determined by the net of the turnover. Instead, it only shows if there has been a gain or loss in the window. As incentive programs usually require a specific increase in the total number of jobs, there has been a problem that no system could determine the number of jobs, only the number of employees. The present system are method is therefore an improvement in calculating methodology that can more accurately determine the actual number of jobs added or lost in the time window for any set time window. This allows for reporting by the employer which is both rigorous enough to stand up to auditing, and provides the government entity with accurate values for verification of compliance.

The term “backfilling” for the purposes of incentive compliance generally refers to making sure that a generic project job, not a specific titled position, is maintained. In other words, the title of a new hire makes no difference when backfilling a vacant project job and a custodian can fill a job previously held by an engineer (or vice-versa). Similarly, an employee may leave with a job disappearing. There is substantial ebb and flow of employees, but not so much of jobs. It is for this reason that the systems and method discussed herein work to create an indicator of the available jobs from the ebb and flow of employees, but they do not use employees as stand-ins for jobs. To put this simply, if a company always wants to have 2 custodians, that is two “jobs” but it should be recognized that at any given instant, it is possible that the company have 0, 1, 2, or possibly even more custodians currently employed While still having two “jobs” for custodians.

The system, in many respects, makes use of the fact that for a large organization, with a large number of jobs, turnover becomes more rational. For example, if a company has 50,000 employees, and, on average turns over 10 employees a day at the end of any given day the company should have between about 49,990 employees (with 10 open positions) and about 50,010 employees (with no open positions). This band will also remain true over time. Thus, if an employer agrees to add 2,000 jobs it one year and has exactly 50,000 employees on day one, they should have between 51,990 employees (10 open positions) and 52,010 employees (no open positions) at the conclusion of the year to have met their requirement. The present systems, however, have no way to accurately measure open positions and the above numbers vary between compliance and non-compliance with the target.

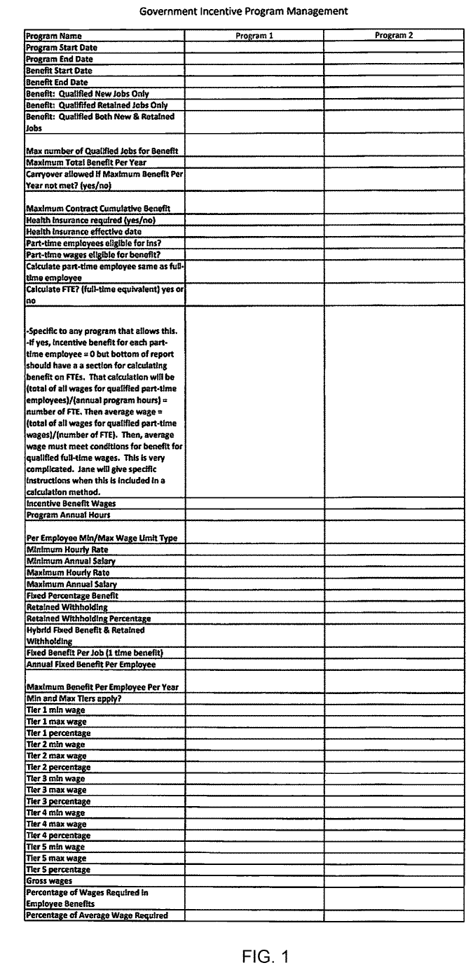

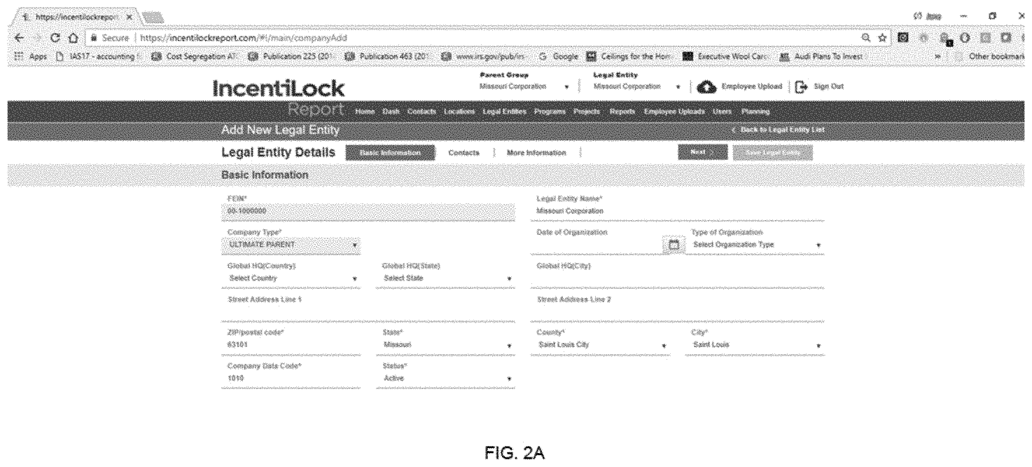

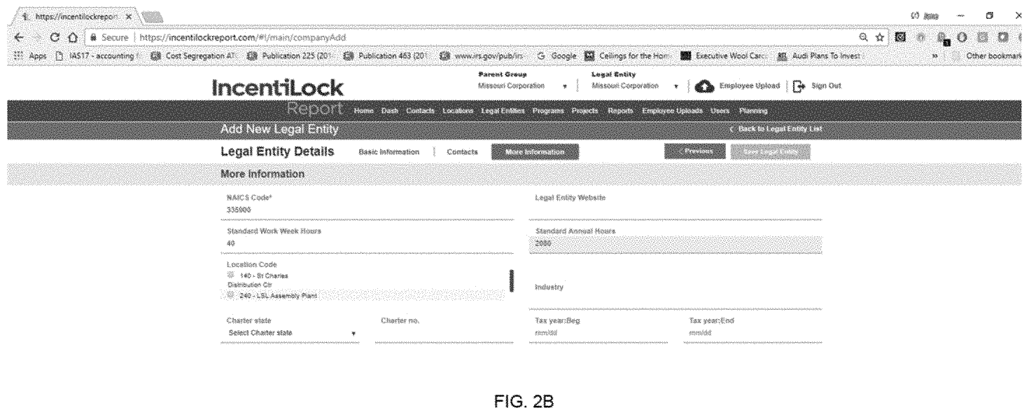

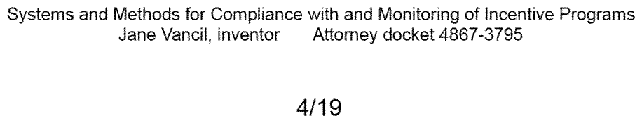

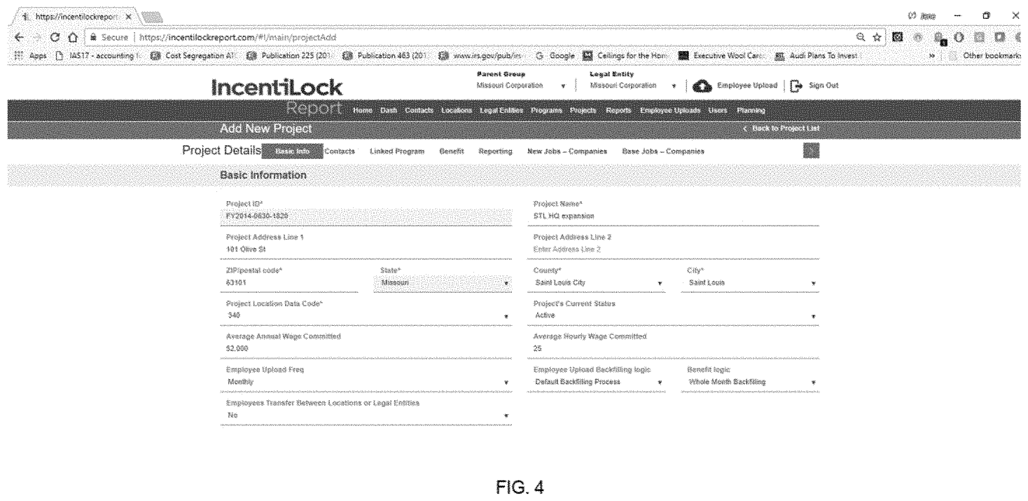

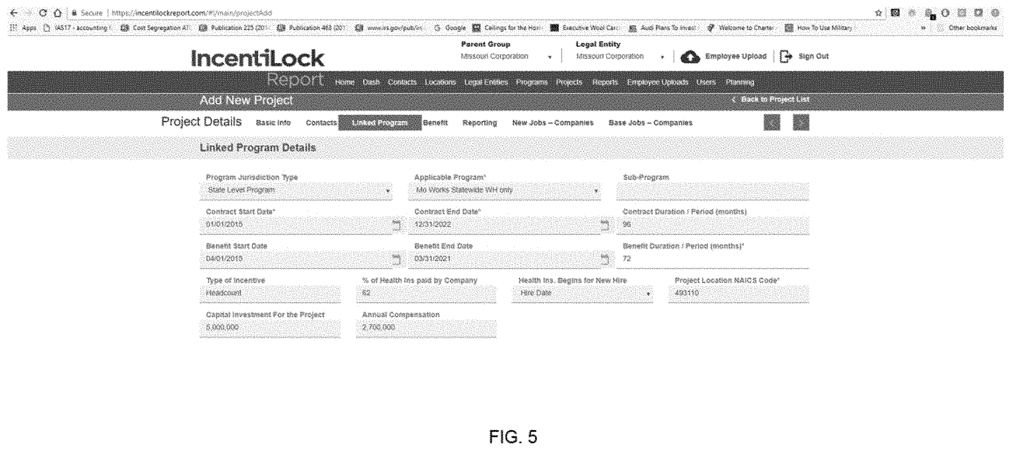

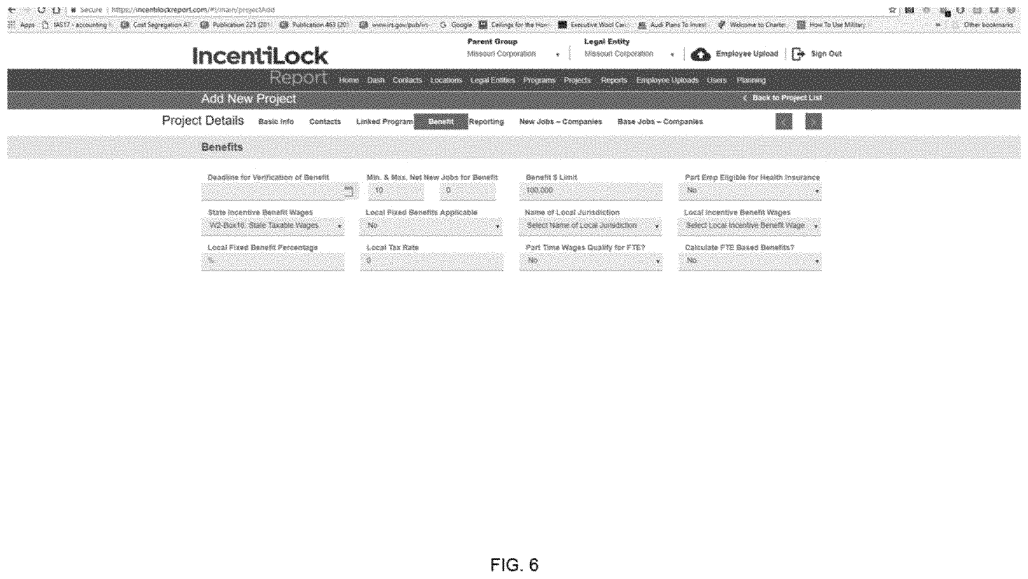

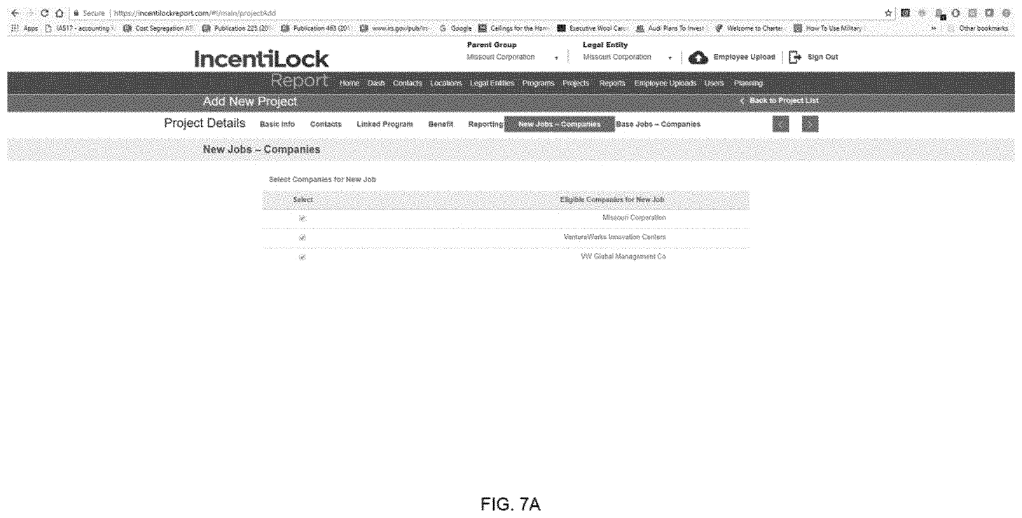

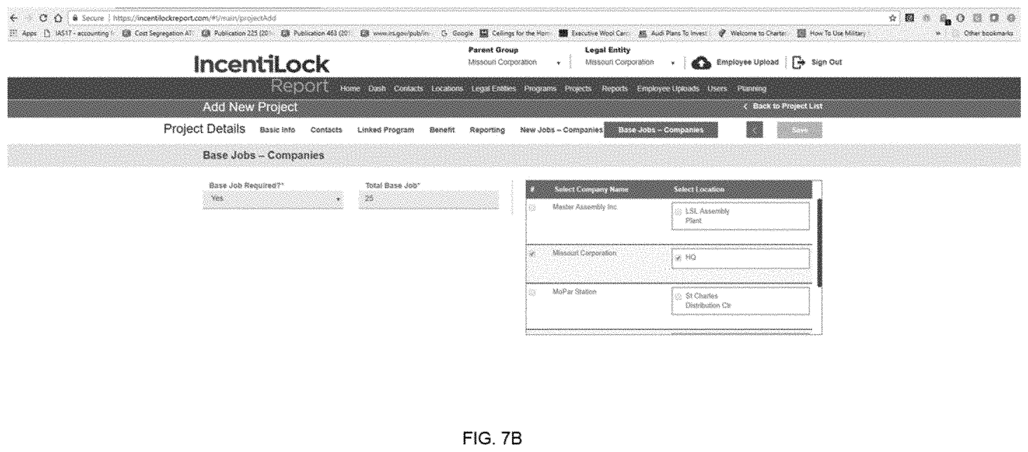

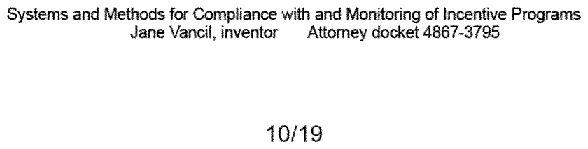

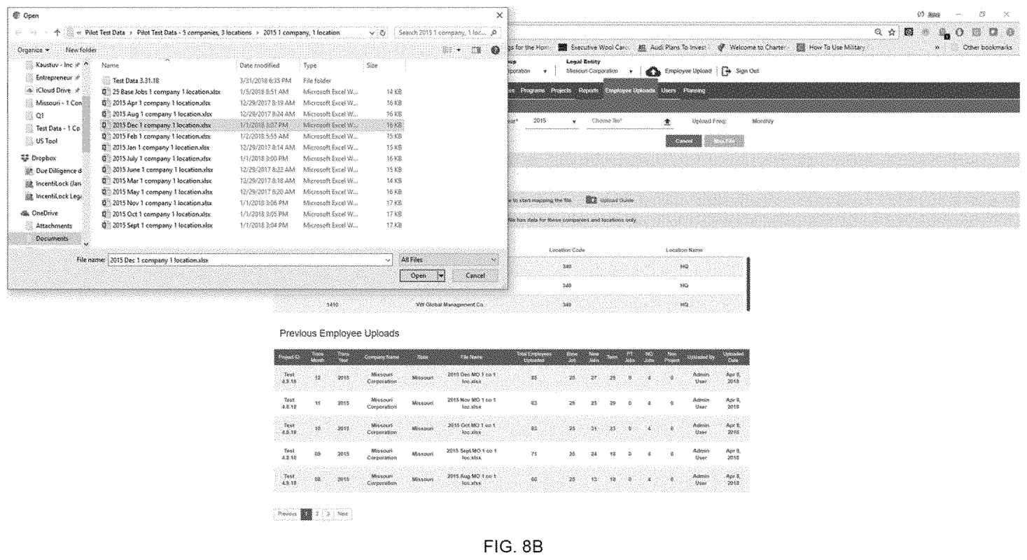

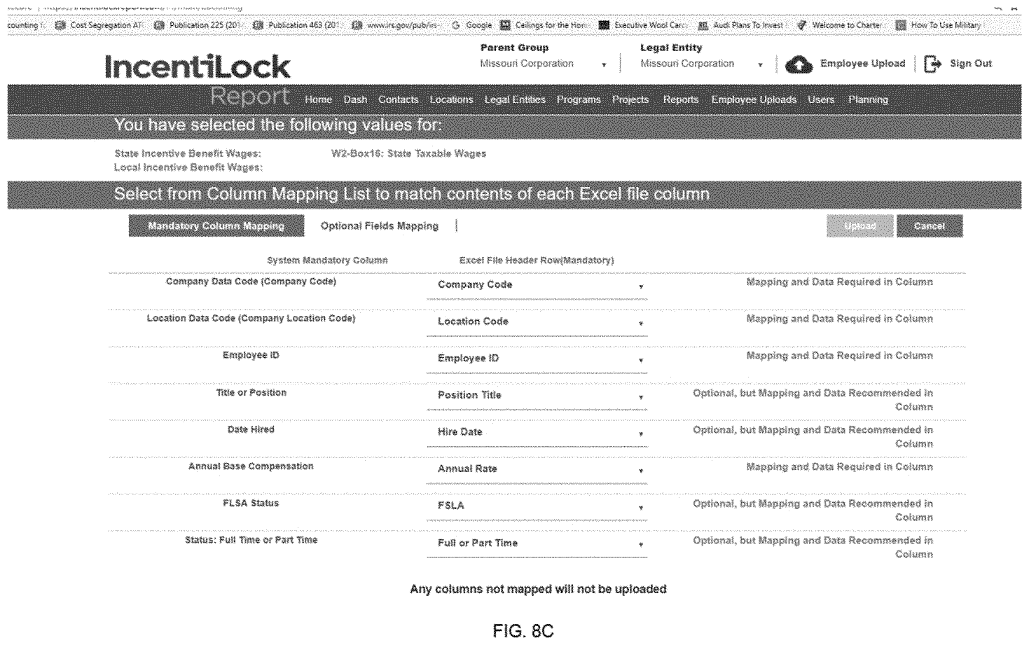

FIGS. 1 through 10B provide for various indications of screens that may be used as part of a computer implementation of the system as well as a flow chart of operations. As should be clear from FIG. 3, systems and methods can utilize a wide variety of different rules related to different incentive programs in their action. In FIG. 3, the rules of various incentive programs are stored and can be selected by a user to provide for the overview of what the rules are that the employer must abide by to have complied. These rules generally relate to the types of backfilling that needs to be done and any specifics about types of jobs that need to be created to meet the requirements. Once the rules are selected, the user will generally upload employment data on particular dates which allows for the system to mesh the data with its own calculations.

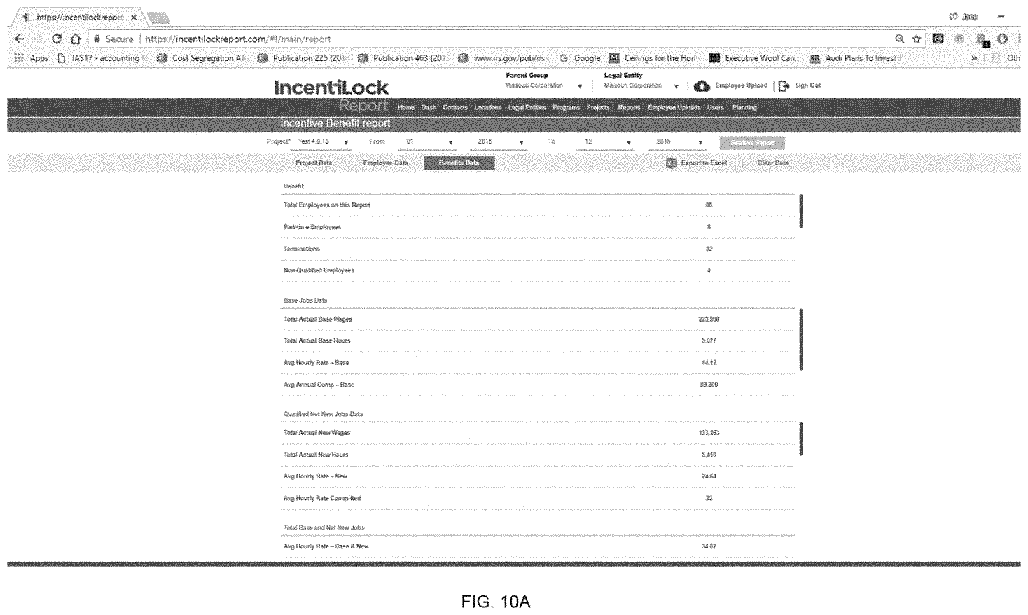

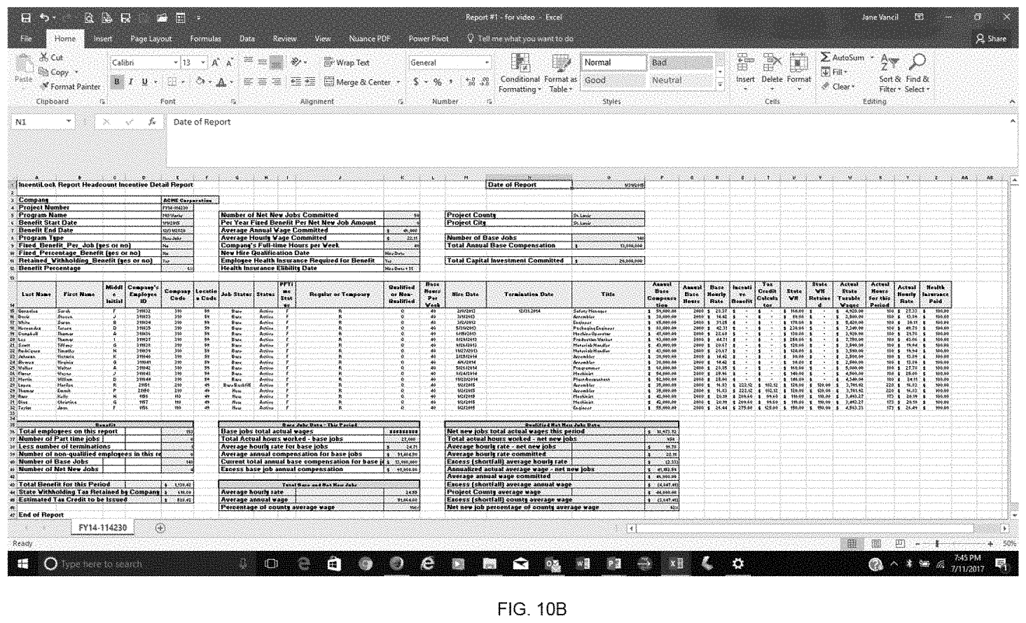

It is important to recognize, as is best shown in FIGS. 10A and 10B that while specific employees are used in the systems and methods as an indicator of a job, the system is not actually classifying employees, but is classifying jobs and specifically jobs which comply with the terms of the incentive. The reason this distinction is important is because an employee's actions are not necessarily correlated to the job position they represent. For example, an. employee can be terminated without their job position being terminated (for example, if they were fired for drug use on the job and the company sought to replace them). Similarly, a job can be eliminated without there actually being a lost employee (for example if an employee is promoted to management and his prior position is not filled). The disparity exists due to the simple fact that the hiring process generally takes time and that a new employee will generally always retroactively fill a job and a job will not be created retroactively for a newly hired employee unless there are already all the prior jobs filled. Thus, a job may be vacant, while an employee cannot. It is also important to recognize that there are actions an employee can take, but those actions are net actually the actions of their “jobs”. However, the employee ebb and flow can be used to show what is happening with the jobs of the employer to determine an accurate indicator of the number of jobs actually available.

Specifically, there will generally be three types of actions that can be taken by an employee at a particular location which indicate the employees relationship to a job. The first of these is that an employee is terminated or otherwise leaves from that location. This can result from an employee that either no longer works for the company, or works for the company, but is now at a different location. Regardless of why the employee leaves, this creates a vacancy, and this loss needs to be indicated as a vacant job in the location that they have left from. However, some vacancies (as defined by job position) will be filled, while others are not.

In terminating an employee, the system will generally identify from employment records that either, the employee has been terminated, or that the employee has had a geographical location change. The former, is generally straight forward as the employee is being removed from the system totally. The later, however, will generally require the system to determine that an employee has had a move. This can be based on a change of address, a change of supervisor, or from any other piece of information that would indicate the employee is at a different facility. In many cases, the system will need to be provided with rules indicative of how the employer's facilities are arranged to treat a move as a termination in job count, for example, if an employer only has two geographically disparate facilities, the location of the job may be determinable from the residence of the employee being nearer to one of those facilities. However, if the employer could have an employee living in a location working at a multitude of different locations that are both inside and outside the relative reporting district (for example commuting across a state line), something else may need to be used. In this case, the movement of the employee can potentially be detected based on which HR system the employee is in, or based on where the employee's paycheck is issued or who the supervisor is and what facility they are at.

A second action is a hiring of an employee. This effectively is exactly the opposite of a termination and may arise from a direct hire, or can be the counterpart action of an employee moving between two locations or positions. Like the termination, the hire will generally he understood to be related, to a particular location either from them being added to that specific location, or through another identifier that allows for an indication that they are now at the specific location. A hired employee will always be filling a vacancy as otherwise they would not have known to apply. Thus, in the system a new hire will always fill a vacancy, even if no clear vacancy exists in the system. This later action, filing a vacancy where no vacancy exists, clearly shows the creation of a job.

The third action of the employer is an employee whose job title changes. This employee will generally not have a physical move, but will have a status change. The job title change may also indicate a geographic change, but for purposes of the present system, the title change is generally ignored as there is no geographic change and, thus, no gain or loss of a job. In effect, a change does not result in any gain or loss of a job, it instead directly moves an employee between jobs which are equal in the incentive's eyes. Thus, there is no vacancy created or filled (or, in an alternative view, a vacancy is simultaneously created and filled).

For certain incentive programs (for example those requiring certain job levels or salaries) the change in title may result in the employee needing to be categorized differently and that can be carried out in alternative embodiments. These can again result in the transition being treated as a terminated and a separately hired employee with two different, categorizations, even though they are the same person. It should be understood that while the discussion herein simply refers to jobs as generic and all equivalent positions to each other (with the exception of the discussion of “surplus” categorization below), the system can readily distinguish jobs by providing categories and treating a change in job category as a gain and loss event between two different categories instead of as no change. Basically, if the incentive program has specific requirements for a job (e.g. salary, title, etc.), the jobs listed can be only those that meet the specific requirements. This is exactly the same way that the geographic location is handled which is why this disclosure can focus simply on a generic “job” with all jobs being equal. The system can be setup so that the jobs are all equal in that a “job” shown in the system meets all the requirements of the incentive job, while any other type of job (which would not be listed) does not.

Recognizing that employees can fundamentally have three different kinds of changes (leave, join, or change), there is then a need to categorize them into specific classifications of jobs based on their involvement with the incentive program and discuss how those actions indicate the total number of jobs available. The key here is to recognize that a job that is left is vacant until a hire takes the job, and a new hire will always be hired to fill a vacancy as a hire cannot be made for a job which does not exist. Because of this arrangement, employees that meet the requirements of having a job which is counted in some way for the incentive, receive one of three categorizations: Base, New, or Surplus.

“Base” employees are those that are indexed to fill a base job that the employer is required to maintain as part of the incentive. In effect, they are the starting base number of jobs that the employer has to increase from. The incentive program will generally require an employer have a net job addition over the period so it is important that new hires to replace old employees not be treated as indicating the creation of a new job. The present systems and methods operate in this fashion and provide that, at the instant that the system starts, the existing employees, and the jobs they represent, are simply all base employees. Thus, the base jobs is defined as the number of employees at the start of the incentive. It is important to recognize that the number of base jobs in the system and method will generally never change regardless of how many employees the company has. It is just that some base jobs may be vacant at any instant including the intimal instant. The key to base jobs is that as the jobs have turnover of employees, the employer will need to make sure that every base job is maintained, before they generally can indicate any additions and the number of additions are usually what is required for the inventive. Further, the base number of jobs may include jobs of a type that cannot qualify for the incentive if added, but are allowed to count for the base.

The particular scenario of interest is the following. If an employee filling a base job is terminated and the company makes no move to hire a replacement, the base lob” has technically been eliminated. However, the company is not allowed to do this under the incentive program and actually needs to create a new job to cover this loss. Trying to line up hires for specific jobs can be too difficult in most HR systems. Thus, the system classifies a base job as immoveable, there will always be the same number of base jobs to be filled regardless of what those jobs are or who fills them. To put this another way, it becomes less likely that the employer has actually added jobs, the more unfilled base jobs that are present, even if the employer has hired a large number of new employees.

The second category of employees are “New” jobs. These are created when employees are added that meet the criteria of an added employee under the incentive. Thus, if the employer above must maintain X jobs and add Y new ones, these would be later Y hires that count toward the new job total and are above the required base. The final category of employees are “surplus”. These are employees that are not currently necessary to fill any position related to the incentive, but are employed by the company and need to be counted for some reason. Commonly, this will be because they cannot count as a new job, but could fill a base vacancy if one existed. A surplus employee may be an employee which is hired above the requirements of hiring to fill new jobs, but will more commonly be an employee that does not meet the current criteria of a new employee but does meet the requirement of a base employee because they are actually replacing a previously departed base employee that had the same criteria dichotomy.

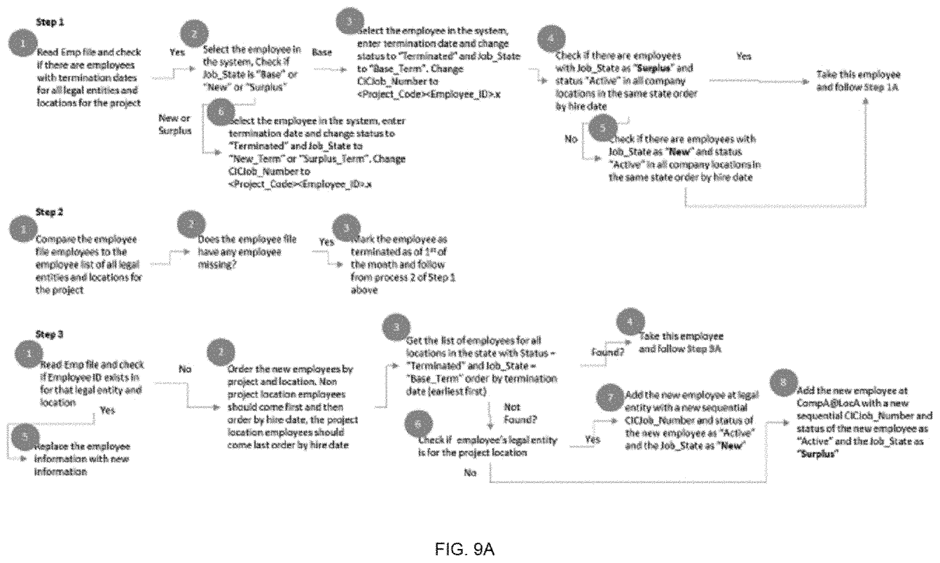

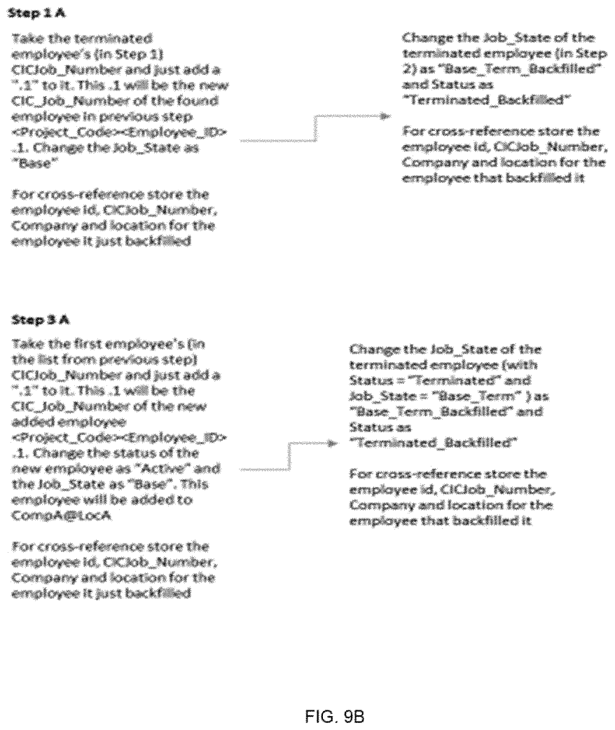

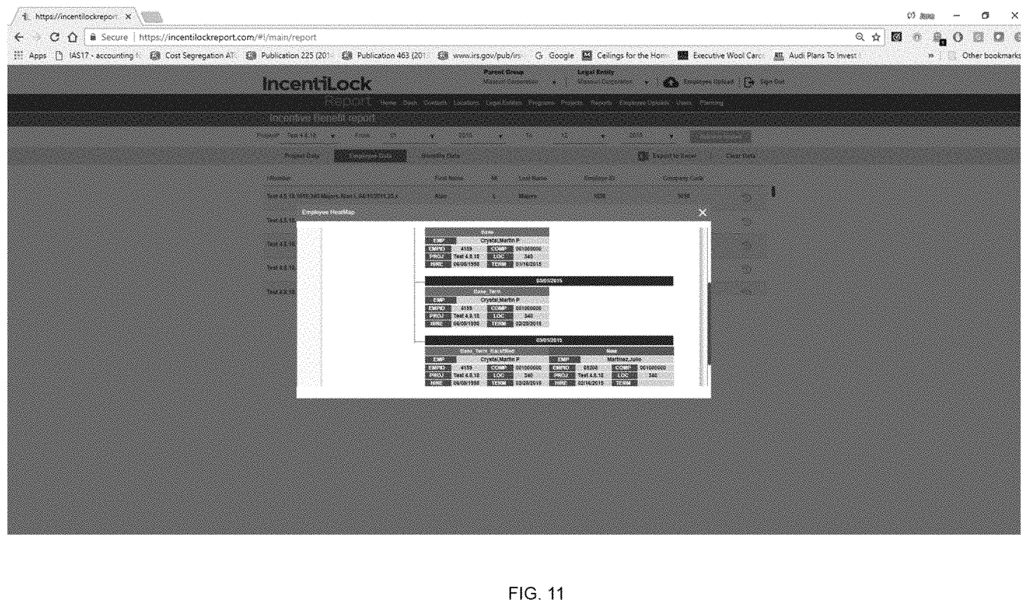

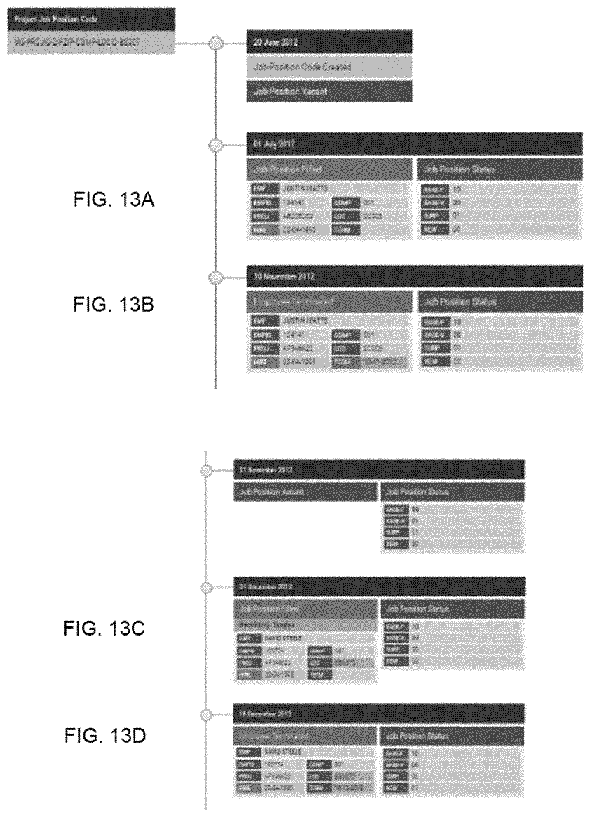

In order to perform the analysis and variation, this disclosure will now walk through a few examples of how the system can categorize an employee and how the system works over time, This will be done primarily in conjunction with FIGS. 9A-13D with particular reference to FIGS. 10A, 10B, and 11. FIGS. 10A, 10B, and 11 essentially show the same activities, but show how different report schemes utilize different recording.

As the system starts at the start of the incentive window, generally all employees are categorized as base employees as they represent the base jobs the employer is required to maintain. Now, an existing employee, who is currently classified as “base” quits. Note that such a departure has to be of a base job as all employees are currently filling base jobs. Upon detection of the termination, there is now an opening for a “base” job. The first thing the system will do is generally determine if there are any “surplus” employees currently available. If there are, that surplus employee's status is changed to base -filing the base job. If there are not (as is the case here), a base-vacancy is created and the first hired employee that meets the criteria necessary to fill a base job (which will commonly have no criteria) will be given the status of base and fill the vacancy. It should be recognized that the base-vacancy is not necessarily filled by the lost employees replacement, it is filled by the first hire that can meet the requirement and the requirement to be classified as base are often less than that as being classified as new.

In an alternative embodiment, the definition of a base job may be slightly modified, For example, a base job may require fulfillment with a full time position or equivalent. In this embodiment, when a new hire is obtained, the system may first assess the full time versus part time job status of an employee based on the specific program minimum hours considered to be full time. This determination may be contradictory to the company's determination of an employee's full or part time status. A conversion under the guidelines of a specific incentive program may, therefore, increase the number of full-time jobs that may backfill vacant base jobs or become new or surplus jobs. In specific incentive programs, were part-time employees may be aggregated into full-time equivalent jobs, this conversion from a company's part-time jobs status for an employee to be considered qualified to backfill a vacant fall-time job or be added as a new job or as a surplus job.

Aggregating of hours in an incentive program job count can create a discrepancy when matched against a company's full or part time job status counts. Alternatively, specific programs may require that a new qualified job have certain status such as that the employee be offered health benefits or health benefits at a certain subsidized level. So, even if an employee who is determined under a specific incentive program to be considered as full-time for purposes of backfilling vacant full-time jobs, another test may need to be applied to confirm whether this newly qualified employee, based on actual hours worked or the offering of health benefits at or above the incentive program prescribed rate, to determine if the employee actually be considered qualified to backfill a job or may need to become a new or surplus job under the requirements of a specific program. Further, in an embodiment, more than one employee may be used to fill a single base-vacancy or create a new job. For example, if a base vacancy required that an employee work 8 hours and there are three base vacancies in the system, the system may allow four 6 hour a week employees to fill the three base vacancies. Should one of these four employees depart. That could then make a single base vacancy. It should be recognized that such a system may assist with an employer who wishes to shift over to a different schedule (e.g. from three shifts to four) in accurately counting jobs created if the terms of the program required 8-hour per week employees, for example.

Generally, when an employee is converted from part-time to full-time by the system, a check of hours worked is often necessary for the employee to retain the full-time qualification. When an employee's hours no longer meet or exceed the specific program hours, the employee may need to be removed from the job count (e.g. count as terminated) creating a base vacancy even though the employee is still employed by the company. If employee's hours again meet or exceed the specific program's required annual hours, the employee may be considered again for qualification under the specific program's requirements and may then backfill a base position or potentially even be considered a new position as discussed below.

In the second scenario, the employer hires an additional hire and this comes into the system while there are no vacancies in the base ranks. This employee, if they meet the criteria for the incentive for new jobs (if there is one) will be classified as new since they are creating a “new job” since the base is already filled. When they join the system, this creates the first “new” job categorization and the employer has now started down the path for increasing their jobs as required. If that employee subsequently leaves, there is no need to backfill this position as it is not part of the base (the employee is not required to maintain this job, only to have created it at the end of the reporting window) and the job is not vacant. Instead it is removed.

A vacancy is not created by removal of an employee classified as new not to inhibit the employer getting credit for additional hiring, but to avoid laying off additional hires to try and skew the numbers. Instead, the “new” job slots cannot be vacant, if there is no employee in them the slot is simply removed. Should a replacement come in for previously terminated new job, the replacement will again first be potentially ranked for open base positions, but if none are open (as would be expected if it is a true replacement), will again be classified as new creating a new job supplanting the old one.

It should be recognized that because there is no need to maintain any number of new vacancies as the new classification has no vacancy setting, it is only necessary to have created a certain number which are filled as of the reporting date, there is no need to have the system backfill the vacant new positions, each employee that is classified as new is simply a new entry and the total filled positions of those entries can be classified as the new jobs. This type of record keeping means that there is no possibility of over reporting new positions. It is also different from “base” jobs because base jobs cannot be eliminated and a base categorized employee will be replaced with a base-vacancy entry. Base jobs have to be maintained pursuant to the requirements of the incentive.

In effect, the requirement to first fill base job positions, which can never be eliminated but are left vacant upon the employee leaving combined with the requirement that new job positions be eliminated with the loss of the employee, most accurately creates a picture of actual hiring and job creation. Specifically, by smoothing out the waves of turnover and using the fact that an employer can not have more employees than they have jobs while they can have less employees than they have jobs, the presence of an employee classified as new clearly indicates the creation of a job, even if there are base vacancies. Any large number of jobs will see turnover and the time to hire a new employee is non-zero, Thus, any position could be vacant at any instant. However, the number in the present system will most accurately reflect what the employer is seeking for employees, which most actively represents the number of jobs available.

For this reason, employees classified as “new” are also not reclassified as “base” even if there is a vacant base position (although this may be done at the time of reporting to meet specific requirements of the entity requesting the report if required). A “new” position is only created when the employee arrives and the base is full. This situation implies that new positions are actually being created by the employer because at that instant there is an extra employee who cannot have been hired to fill a position previously left vacant. To put this another way, you cannot hire an employee for a position which didn't exist. Thus, the presence of an employee above the base (classified as new) is a clear indicator that the employer has created a position above the base which means that a job has been added. Further, to the extent that there already were employees above the base, a further increase in total represents continued additional hiring.

Every employee hired above the base (and above any currently employed new hires) indicates an actual new job being created, even if a vacancy opens up later anywhere. Thus, the employee classified as “new” must represent a newly created job and cannot be a replacement (even if that new hire is a specific replacement, as that would mean the employee currently filing that base job was actually new, or some similar pattern of increasing complexity). Basically, the system will always indicate the maximum number of employees the employer had during the reporting window which is a good indicator that at least that many jobs exist at the end of the reporting window. As these windows transition through the entire period, consistency is clearly indicative of actual job creation.

While the above is very good at showing actual hiring, there can be scenarios where a third classification is desirable. This classification is “surplus” and will often behave as new. However, a surplus employee is not only allowed to, but is expected, to fill a base job position if one becomes vacant as opposed to staying surplus. A surplus employee will generally get created because there is no vacancy to add them anywhere (all base positions are filled) and because a new job requires a specific type of employee categorization to fill it that the present employee does not qualify for. Another possibility is that the employer already has as many new employees as they need and it is undesirable to add extras or if the entity monitoring compliance will require shifting of employees within categories at the end of the reporting period.

A surplus employee is one that cannot be classified as new for whatever reason. This will commonly be because they do not meet specific requirements of the newly created positions. However, the surplus employee will generally meet the (usually lower) requirements of a base classified employee and can be valuable for backfill of base. Thus, an employee categorized as “surplus” and is often created because the system always backfills the base first. Thus, an. employee that could have been classified as new (and actually was new) was actually classified as base eliminating a base vacancy while the actual replacement for that base vacancy was hired later (and can now be classified as surplus). A surplus employee is only classified as such because the base is full (no base vacancies) and this employee cannot be classified as new due to specifics of the rules for some reason. Thus, they are classified as surplus to show that there clearly was a new job created, but it may not qualify under the rules of the incentive.

As in the case of classified-new employees, it is generally not possible to have a surplus employee without the creation of an actual new position. Again, an employer cannot hire more employees than they have jobs available. The presentation of an employee being surplus as opposed to new is simply a recognition that while this employee actually represents a new job position, they, for whatever reason, cannot be classified as having such a job position so they cannot be used to show its creation. In effect, it means that an employee which should be new has been inaccurately classified as base or the employer has created a new position which does not count under the incentive. Both of these are highly likely in large organizations with large turnover. For example, hiring of executives may count under the incentive while hiring of their assistants does not. However, as new executives arc hired, their assistants will also need to be hired. As it is not clear which category a new hire is in, the system may simply classify the extra assistants as “surplus” as these can fill base positions. By having the surplus employee immediately fill a vacant base position, this allows normal turnover to, over time, eliminate or reduce the misclassification effect on job calculation.

Being classified as surplus makes these employees the first to fill a base vacancy when it is created (even before new hires), the system will automatically look to the surplus to fill a “base” position before any hiring occurs. This means that an employee that can only be classified as base, is now used to fill the base vacancy, The logic of the pattern is that this surplus employee was to fill a specific base position that was vacant but that base vacancy was filled by someone else. This allows them to be correctly positioned as base at the soonest opportunity. Further, as a “new” employee will generally not get reclassified as base except in certain reporting specific scenarios, it keeps the new employees which meet the required criteria of being new from being reclassified as base, not correctly showing increased hiring.

It should be recognized that as the reporting period approaches and a report needs to be run there can be a desire to review the records and see if there are any positions that can be moved. If there are no surplus employees, there is generally no need. All employees fit a criteria and are useable to show compliance even if there is a possibility of a base job being vacant. If there are a large number of surplus employees, representatives of the employer may purposefully review the employees classified as base to see if there are some that should be classified as new to allow for a conscious correction of the misclassification of a new employee to a base position. Generally, this will not be the case, however, because a large number of surplus employees will generally only arise if the specifics of new jobs are quite narrow and a large number of employees meeting this criteria happen to be hired just when a large number of base employees leave. As hiring is generally much more level and does not involve large groups, this scenario is unlikely. Further, it will commonly also not happen since, as discussed above, jobs between base and new are usually considered generally fungible and have the same criteria in most cases. If differences exist between new and base jobs, it is often beneficial to redefine the criteria to have the requirements match than it is to utilize the surplus category.

Further, new jobs may be reclassified as base at the reporting time if there is not a criteria specific to new jobs and there are a large number of vacant base positions, or long empty base vacancies, as this can more accurately reflect the total hiring that has occurred particularly if the reporting window is long. The base positions may be left vacant at reporting (if there is no surplus) as this may actually better show the current “jobs” available and the specifics will generally depend on the incentives rules but this will often be more accurate if the reporting window is relatively short, or if there are multiple sub-windows of reporting within a main window. In most cases, the existence of new positions (namely employees classified as new even if there are base vacancies) will indicate actual hiring above prior levels. This is because the new positions cannot have been created if there were open base vacancies and open base vacancies with filled new positions (using backfilling as discussed above) is indicative of normal job turnover at a total job level above the base and commonly at or above the level indicated by the total of employees classified as new.

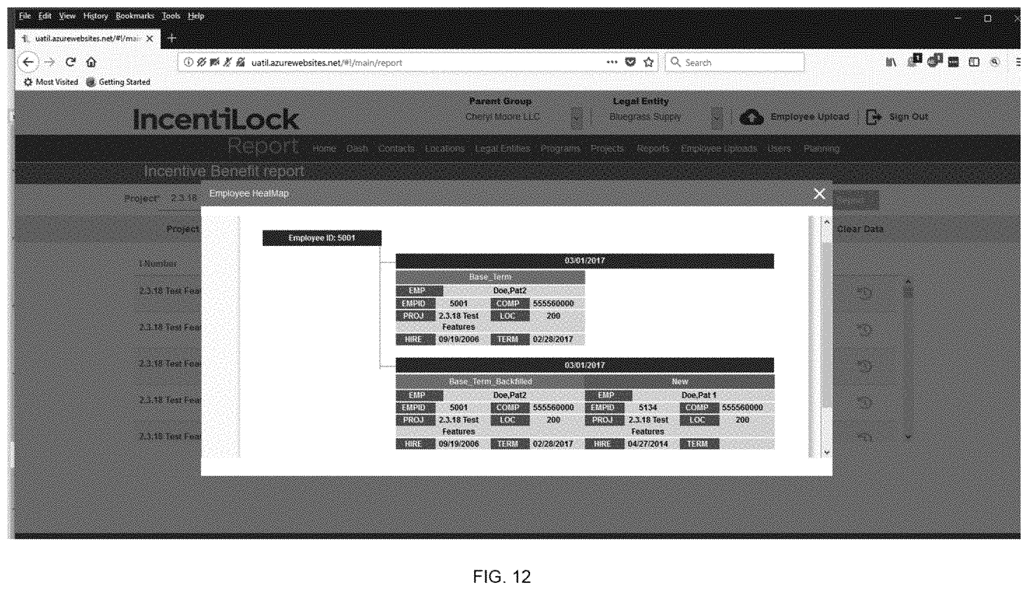

FIGS. 11 and 12 show how specifics of reporting can influence how jobs are filled at certain times. Specifically, in the arrangement of both FIGS. 11 and 12, the first out first in fill of base jobs as discussed above is used. However, in FIG. 11, the jobs are only filled at a particular time (specifically the end of the month—a longer window) while in FIG. 12, the jobs are filled the day following any vacancy being created (as shorter sub-window). The systems ultimately reach the same calculation for number of jobs at the reporting period (the end of the month) however in FIG. 12, because of the need to immediately fill, a new job employee will more often be used to fill a base job slot. This will generally be the case if the new and base jobs have the same requirements (no surplus).

Based on the above the value of the systems and methods should be apparent in showing an actual increase in hiring (job creation) at the end of the reporting period even if all positions are not currently filled. The value of always backfilling first is that it “counts” a vacancy in base as a job which can be presumed to exist, while not maintaining a vacancy created in new does not allow for termination of a position to actually represent a job.

This generally works because an employer cannot have more employees than they have available jobs, although they will commonly have less. For example, an employer could not have 510 employees if it only had 500 jobs. To have 510 employees, one has to have at least 510 jobs at the instant it had 510 employees. That means that if at any point in the reporting period there were 510 employees, there have to have been at least 510 jobs in existence at that point. Thus, if at the end of the reporting period (so long as the period is relatively short, e.g. a month), there are actually 490 filed base positions and still 10 filed new positions, it is actually a safe assumption that 510 jobs actually exist at the end of the reporting position and the discrepancy is simply due to natural ebb and :flow.

Another value of this form of calculation is that since it takes into effect the expected ebb and flow of employees over time, it is harder to artificially inflate the values. Employers who eliminate base jobs cannot easily show any increase in jobs unless they legitimately created more jobs than they eliminate before they eliminate them. Again, since an employer cannot have more employees than it has jobs, an employer attempting to have the system show 510 jobs when they only offer 500 is very difficult. To do this, the employer would have to offer 510 jobs at some point in the reporting window (remember the employer cannot have more employees than they have jobs). After this time, the employer would then need to eliminate 10 employees categorized as base. If they laid off 10 of the new employees, this would result in the final number actually being 500 (since vacancies are not created by the departure of an employee classified as new). Thus, they would have to eliminate 10 base jobs in the window. If they simply terminated 10 base employees (likely undesirable for business reasons) they could end up with the 490 base and 10 new of the above scenario (indicating 510 available jobs) in this reporting window. However, in the next window, the 10 eliminated base jobs would be filled prior to any new creation, and this would likely show a decrease in the total. A similar scenario happens by an employer not replacing leaving employees.

Basically, game playing by an employer to show an increase while actually decreasing would require an employer to create the required new positions before old positions arc terminated, terminate the positions, and then avoid any additional turnover from new employees. While this is possible, it is difficult to correctly anticipate, making game playing difficult. Further, it would generally only work for one reporting window and the earlier in the window it occurs, the harder it is to maintain the falsified number. Instead, to accurately hit the end number, the employer would either need to create excess new positions before eliminating old positions (e.g. they actually had 520 positions during the reporting period which they later reduced to 500 to show 510) which may be perfectly acceptable to the governing body administering this, or they would need to eliminate the positions very close to the end of the reporting period, something which is likely readily discernable from other records. For example, the firing of 10 base employees immediately prior to the reporting period end is likely to result in the reviewing body not counting those as vacancies without a legitimate explanation. As discussed above, the employer could also be forced to fill all base-vacancies with classified new employees immediately prior to reporting, or immediately after. The later is particularly useful to avoid manipulation within multiple sub-windows if base and new employees have the same criteria for selection.

As should be apparent from the above, the present system can allow for an employer to show that they have legitimately increased their number of jobs above a specific amount even if at the actual time of reporting their number of employees was less than that target amount of jobs. This works because the system effectively allows for the employer to provide the maximum number of employees they had within the calculation window (e.g. prior month) as the number of current jobs at the end of that window (end of the month). Thus, the system takes into account that recent departures within the immediately prior calculation window, are likely unfilled only due to transitional effects. Further, it is difficult for an employer to attempt to artificially inflate this number as inflation of the number requires actual creation of excess jobs followed by elimination of them with no loss due to expected turnover. Alternatively, it requires actual creation of the desired jobs and then taking specific actions which are readily detectable in other ways. It should he noted that even in the artificial inflation scenario, the employer actually has to create and fill jobs before terminating others and this may actually be acceptable under the terms of the incentive and would clearly involve a non-zero cost making it highly undesirable in most cases. Further, such game playing will generally only work in a single reporting window, so incentives which utilize multiple windows over time for compliance make such game playing additionally difficult.

For purposes of reporting, the system can generate reports which can be provided to the governmental entity to show compliance. The files generated from the various analyses may take the form of any protocol storage medium or file type known now or later discovered including, but not limited to, FASTQ files, binary alignment files (bam) *.bcl, *.vcf, Excel and/or *.csv files. The output files may be in formats that are compatible with available data viewing, modification, annotation, and manipulation software, Accordingly, the accessible sequence data as provided herein may be in the form of raw data, partially processed or processed data, and/or data files compatible with particular software programs. Further, the output files may be compatible with other data sharing platforms or third party software.

In an embodiment, there is a system for analyzing payroll data and calculating incentive benefits related to headcount-based incentive programs and policies, comprising: a cloud computing environment in communication with a plurality of sequencing devices, wherein the cloud computing environment comprises at least one server, the server being configured to communicate with a sequencing system remote from the server to receive and store sequence data from the sequencing system while the sequence data is being generated.

The system may comprise a sequencing module configured to generate the sequence data and a communications module configured to communicate the sequence data to the server.

In an embodiment of the system, the communications module is configured to receive a user instruction related to communicating the sequence data to the cloud computing environment, and wherein a default state of the communications module is to communicate the sequence data to the cloud computing environment in an absence of the user instruction.

In an embodiment of the systems, the sequence data comprises data derived from uploaded data by clients and customers.

In an embodiment of the system, the sequence data comprises period and sequential payroll and finance data as uploaded by clients and customers for the purpose of calculating incentives and tax credits.

In an embodiment of the system, the cloud computing environment comprises at least one processor configured to receive the upload data.

In an embodiment of the system, the communications module is configured to communicate a user instruction related to analysis of the upload data using the cloud computing environment, and wherein the data is analyzed and manipulated by the cloud computing environment based on the user instruction and/or selection of incentive programs without further instructions by the user.

In an embodiment of the system, the cloud computing environment comprises at least one processor configured to: receive one or more instructions related to sharing the sequence data from an originator of the sequence data.

in an embodiment of the system, the cloud computing environment comprises at least one processor configured to: receive a request from a secondary user related to the sequence data; authenticate the secondary user based on instructions provided by the originator of the data; and provide the data to the secondary user if the secondary user has permission to access the data,

In an embodiment of the system, the upload data is stored on the cloud computing environment.

In an embodiment of the system, the upload data is not stored after calculations are complete, as determined by the user.

In an embodiment of the system, the communications module is configured to distribute the sequence data to a plurality of computer systems connected to the communications module for analysis of the sequence data.

In an embodiment of the system, the cloud based network is configured to determine processing capabilities of computers of the plurality of computer systems, and to distribute the sequence data for analysis based upon the determination.

In an embodiment of the system, the cloud computing environment provides a user-interface graphic dashboard of metrics suitable for tracking incentive projects on a specific period basis (at the user's discretion), individually and in aggregate.

In an embodiment of the system, the cloud computing environment provides a repository for incentive-related project documents, where users may upload documents in various document formats.

In an embodiment of the system, the cloud computing environment provides for headcount or payroll reverse audit project management, including original or reverse calculations, data manipulation and benefit analyses.

In an embodiment of the system, aggregate data may be used in mobile application development to create an application that tracks headcount by location with said application to be available for licensing to the owners of the data.

In an embodiment, there is provided a computer implemented method for analyzing upload data in a cloud computing environment, comprising: receiving, at a server, a request from a user to annotate upload data stared on a cloud computing environment; determining if the user has permission to annotate the upload data; modifying the upload data based on an instruction related to an annotation if the user has permission to annotate the upload data; and storing the upload data with the annotation.

In an embodiment of the method, the annotation comprises information about the user.

In an embodiment of the method, determining if the user has permission to annotate the upload data comprises determining if the user is an owner of the upload data.

in an embodiment of the method, the annotation is visible only to secondary users that have permission to view the upload data.

In an embodiment of the method, artificial intelligence is implemented to identify and track employee data without capturing or storing personally identifiable information for each employee.

In an embodiment of the method, the process of calculating cash and tax credit incentive benefits is automated within the cloud computing environment.

In an embodiment of the method, artificial intelligence is implemented to automatically convert company job titles to broad job titles suitable for maximizing incentive project job position replacement maximization.

In an embodiment of the method, the reporting feature of the cloud computing environment handles incentive benefit calculations without the use of computer programing code to effect calculation methods.

In an embodiment of the method, the cloud computing environment creates an alert to client and customer users that incentive project benefits are in jeopardy of decertification and/or clawback of benefits previously received.

In an embodiment of the method, the cloud computing environment provides plug-ins for various complementary software or applications, for example, calendar deadlines, document conversions from pdf into other document formats.

In an embodiment of the method, the cloud computing environment provides a user-interface graphic dashboard of metrics suitable for tracking incentive projects from inception to date, individually and in aggregate, at the user's discretion.

While the invention has been disclosed in conjunction with a description of certain embodiments, including those that are currently believed to be the preferred embodiments, the detailed description is intended to be merely illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

What is claimed is:

1. A method for an employer to qualify for an incentive benefit under a government employment incentive program, the method comprising:
for an initial time T0:
determining number of employees of the employer receiving a paycheck (E_{T0}), subtracting, from E_{T0}, the number of employees scheduled to work part-time or showing actual hours worked less than full-time hours for the time period, thereby determining number of remaining employees (R_{T0}), subtracting, from R_{T0}, the number of employees with titles not qualified for the incentive benefit under rules of the incentive contract program, thereby determining number of qualifying employees (Q_{T0});
hiring a plurality of new employees between T0 and a later time T1;
at the later time T1:
determining number of employees of the employer receiving a paycheck (E_{T1}), subtracting, from E_{T1}, the number of employees scheduled to work part-time or showing actual hours worked less than full-time hours for the time period, thereby determining number of remaining employees (R_{T1}), subtracting, from R_{T1}, the number of employees with titles not qualified for the incentive benefit under rules of the incentive contract program, thereby determining number of qualifying employees (Q_{T1});
determining difference between Q_{T1} and Q_{T0} (N_{T1}), wherein if N_{T1} is positive, the employer qualifies for the incentive benefit.

2. The method of claim 1, wherein the time difference between T0 and T1 is at least one month.

3. The method of claim 1, wherein the time difference between T0 and T1 is at least a year.
